(19) United States
(12) Patent Application Publication
(10) Pub. No.: US 2011/0297722 A1
(43) Pub. Date: Dec. 8, 2011

(54) Duct securing gun

(76) Inventors: Henry E. Pritchett, JR., Byron, GA (US); Charles J. Tyner, Savannah, GA (US)

(21) Appl. No.: 13/134,010

(22) Filed: May 26, 2011

Related U.S. Application Data
(60) Provisional application No. 61/396,755, filed on Jun. 2, 2010.

(51) Int. Cl. B25C 1/00; B25C 7/00

(52) U.S. Cl. 227/12; 227/47

(57) ABSTRACT

A duct securing gun comprising: a holder for retaining a material, a fastener driver for installing at least east one fastener, a track to align the material with respect to at least one of the holder, and the fastener driver, wherein the fastener driver installs at least one fastener to secure at least one end of the material. The fastener driver comprising of a cutout to allow for the material and fastener to exit the track unobstructed the majority of the time.

### CROSS-REFERENCE TO RELATED APPLICATIONS

This application claims priority to U.S. provisional patent application No. 61/396,755, filed Jun. 2, 2010, entitled “Duct Securing Gun”.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Supporting a duct or a pipe with a strap inhibits unwanted movement in a duct or a pipe. This has been accomplished with a strap, and a hammer and nail, or a screw and screwdriver. The installer must hold the strap, the nail, the hammer, or screw and screwdriver, and a duct or a pipe at the same time to complete the installation.

### BRIEF SUMMARY OF THE INVENTION

The present invention provides for a duct securing gun, comprising a holder, a material retained by the holder, a track for aligning the material, a fastener holder, a fastener driver for installing a fastener in the material, a cutter for separating the material dispensed from the material retained in the holder, further comprising an advancer movable in a revolving cycle with respect to at least one of the holder, the track, the fastener holder, the fastener driver, and the cutter, wherein for a portion of the cycle the material moves freely to exit one end of the track. In another preferred aspect of the present invention, the fastener driver further comprising a trigger to activate the fastener driver, the advancer, and the cutter, wherein the fastener driver and the cutter completes a cycle, the advancer is configured to move the material through the track. In another preferred aspect, wherein the material moves from the holder through the track. In another preferred aspect of the invention, the cutter comprising a cutter button, wherein the cutter button activates the cutter, the majority of the time. In another preferred aspect, the fastener driver further comprising of a light, to illuminate the work area In another preferred aspect, further comprising at least one exit, entrance and cutout, wherein the fastener and the material move through the holder and the track, to exit unobstructed. In another preferred aspect of the present invention, wherein the holder and track are configured to move and dispense material.

The present invention provides for a duct securing gun, comprising a holder for retaining a material, a fastener driver for installing at least one fastener, a track to align the material with respect to at least one of the holder, and the fastener driver, wherein the fastener driver installs a fastener to secure at least one end of the material. In another aspect the material in the holder moves freely through the track, and the track further comprising a tension adjuster to apply various pressures to inhibit the material from retracting into the track. The track comprising at least one access hole to position the material through the track. In another preferred embodiment, at least one end of the fastener drive is configured to pivot.

### BRIEF DESCRIPTION OF THE SEVERAL VIEWS OF THE DRAWING

FIG. 1 shows a view of a preferred embodiment of a duct securing gun;

FIG. 2 shows a bottom cutaway view of a track depicting the path of the material;

FIG. 3 shows a front view of a fastener driver and plunger depicted in FIG. 1;

FIG. 4 shows a bottom view of a track with a fastener exit and a cutout;

FIG. 5 shows a view of another preferred embodiment of a duct securing gun described herein;

FIG. 6 shows a view of another embodiment of a duct securing gun, and a repositioned holder described herein;

FIG. 7 shows a front cutaway view of FIG. 6 with a roller and a cutter;

FIG. 8 shows a view of another preferred embodiment of a duct securing gun;

FIG. 9 a front view of FIG. 8 shows a fastener exit and a plunger;

FIG. 10 a perspective view of another embodiment with a fastener driver pivot point;

FIG. 11 a side view of FIG. 10 shows a fastener driver pivot point; and

FIG. 12 shows an example of the material supporting a duct.

### DETAILED DESCRIPTION OF THE INVENTION

In the following description, the use of “a”, “an”, or “the” can refer to the plural. All examples given are for clarification only, and are not intended to limit the scope of the invention. When used in this specification, unless the context otherwise indicates - the term “advancer” means a device configured to move a material into position.

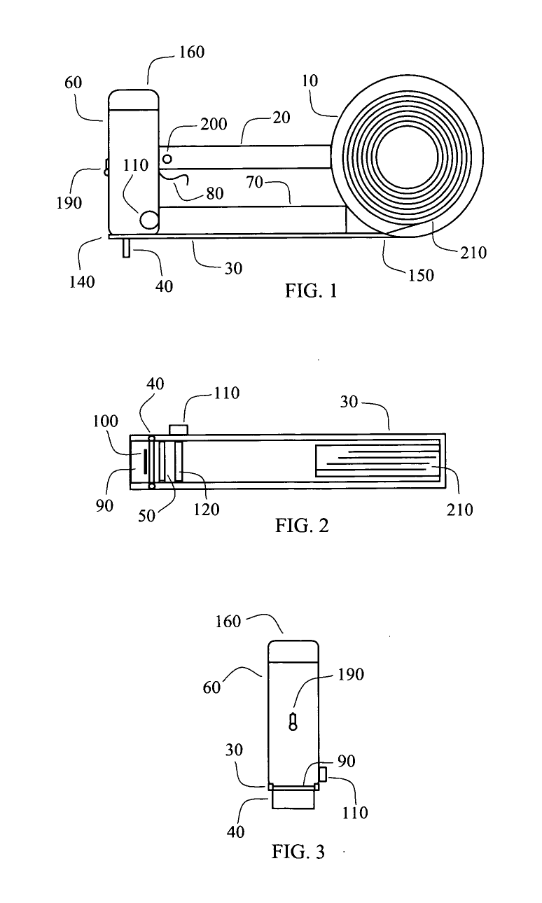

Referring to FIG. 1, according to an embodiment, comprises of a holder 10, a grip 20, a track 30, a plunger 40, a fastener driver 60, a fastener holder 70, a trigger 80, an advancer 110, a track exit 140, a track entrance 150, a power supply 160, a light 190, a cutter button 200, and a material 210. Install the material 210 in the holder 10, and feed the material 210 through the track entrance 150 in the track 30 until the material 210 reaches the advancer 110 at one end of the track 30. Activate the advancer 110 with the trigger 80 to position the material 210 past the plunger 40 and past the track exit 140. While holding the grip 20, depress the plunger 40 against target area, activate the fastener driver 60 with the trigger 80, wherein the fastener driver 60, configured to install a fastener from the fastener holder 70, and into the material 210 and the target area. Secure one end of the material 210 to the target area with at least one fastener, hold the grip 20 and pull the present invention to dispense the material 210 from the holder 10 and through the track 30. Dispensing the material 210 around a duct, cable, or pipe, and aligning the plunger 40, an additional time, against target area, squeeze the trigger 80 to activate the fastener driver 60, configured to install at least one additional fastener into the material 210, and into the target area an additional time. Press the cutter button 200 to disconnect the material 210 in the track 30 from the material 210 in the holder 10. Separated from the material 210 in the holder 10, wherein the material 210 exits through the track 30 at the track exit 140, wherein the fastener exits the track 30 unobstructed, the majority of the time, via the track 30. The advancer 110 activates upon the release of the cutter button 200 to position the material 210 in the holder 10, past the plunger 40 for additional applications. The fastener driver 60, configured to operate with the power supply 160 and the trigger 80. With the movement of the trigger 80, the light 190 configured to illuminate the target area, and configured to turn off during inactivity.

Referring now to FIG. 2, which shows a cutaway view of the bottom of the track 30. The track 30 comprises of a cutter 50, a cutout 90, a fastener exit 100, the advancer 110, a roller 120, and the material 210. The material 210 moves through the track 30 to engage with the roller 120. The advancer 110 activates the roller 120 to position the material 210 past the plunger 40. Fasteners, from the fastener holder 70, dispensed through the fastener exit 100, secures the material 210 to the target area, wherein the cutout 90 allows a fastener and the material 210 to exit the track 30 without obstruction, the majority of the time. When a quantity of the material 210 is dispensed, the cutter 50, configured to separate the material 210 in the track 30 from the material 210 in the holder 10, and shown in further detail in FIG. 1. Separated, the material 210 could now exit the track 30.

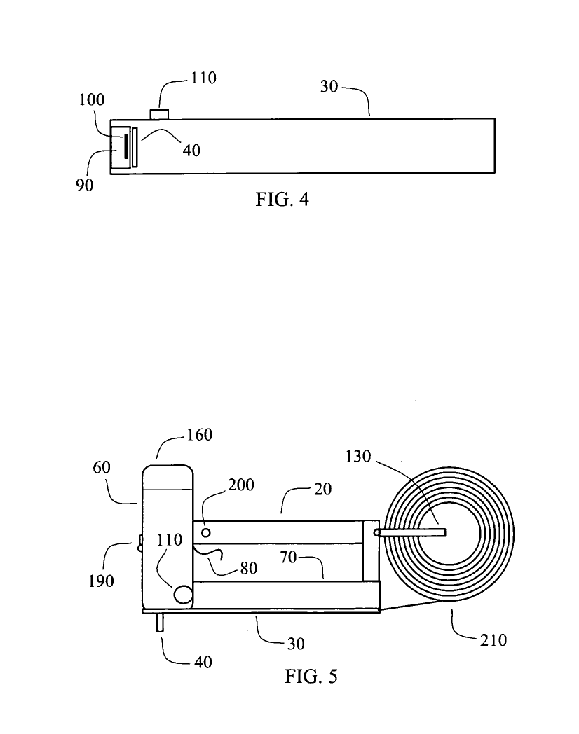

Referring now to FIGS. 3 and 4, a front view of the fastener driver 60, and a bottom view of the track 30. FIG. 3 comprises of the track 30, the plunger 40, the fastener driver 60, the cutout 90, the advancer 110, the power supply 160, and the light 190. FIG. 4 comprises of the track 30, the plunger 40, the cutout 90, the fastener exit 100, and the advancer 110. The material 210, shown in further detail in FIG. 2, travels down the track 30 to the advancer 110. The advancer 110 positions the material 210 past the plunger 40. The fastener driver 60, configured to send a fastener through the fastener exit 100, and install at least one fastener into the material 210 and target area to secure one end of the material 210 to the target area. The fastener and the material 210 configured to exit the track 30 through the cutout 90, without obstruction, the majority of the time. The fastener driver 60, configured to operate with the power supply 160. The light 190 configured to illuminate target area to assist operation of the present invention and the light 190 configured to turn off during inactivity.

Referring now to FIG. 5, in another embodiment, an open holder 130 retains the material 210 before entering the track 30. The material 210 travels down the track 30 to the advancer 110. The trigger 80, configured to activate the advancer 110, and the advancer 110, configured to position the material 210 past the plunger 40. While holding the grip 20, depress the plunger 40 against the target area and pull the trigger 80 to activate the fastener driver 60. The fastener driver 60, configured to install at least one fastener from the fastener holder 70 and into the material 210 and the target area to secure the material 210 to the target area. Securing one end of the material 210 to the target area with at least one fastener, hold the grip 20 and pull the present invention to dispense the material 210 around an item to secure, such as a duct, cable or pipe. Depress the plunger 40 against the target area, activate the fastener driver 60 to install at least one fastener from the fastener holder 70 and into the material 210 and the target area an additional time. Press the cutter button 200 to separate the material 210 in the track 30, from the material 210 on the open holder 130, and the material 210 configured to exit the track 30. The advancer 110 configured to activate upon release of the cutter button 200, and the advancer 110 configured to reset the material 210 past the plunger 40 and the fastener exit 100, for additional applications. The fastener driver 60, configured to operate with the power supply 160. With movement of the trigger 80, the light 190 illuminates the target area, and configured to turn off during inactivity.

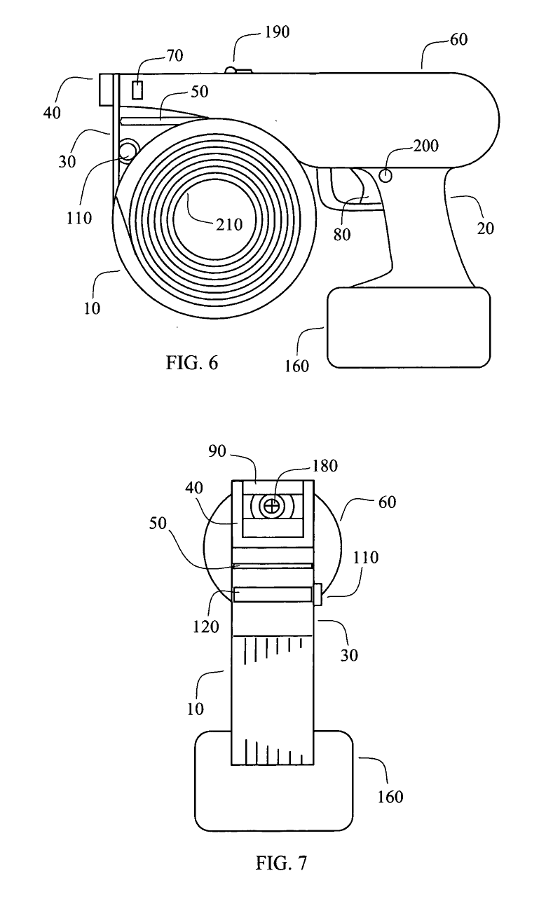

Now referring to FIG. 6, in another embodiment, comprises of the holder 10, the grip 20, the track 30, the plunger 40, the cutter 50, the fastener driver 60, the fastener holder 70, the trigger 80, the advancer 110, the power supply 160, the light 190, the cutter button 200, and the material 210. The trigger 80 configured to activate the advancer 110 and advance the material 210 through the track 30. The material 210 moves through the track 30, and the advancer 110 is configured to positioned the material 210 past the plunger 40. While holding the grip 20, depress the plunger 40 against the target area, squeeze the trigger 80, and the fastener driver 60 configured to install at least one fastener from the fastener holder 70, through the fastener exit 100 and into the material 210 and the target area. Securing one end of the material 210 to the target area with a fastener, hold the grip 20 and pull the present invention to dispense the material 210 around an item to secure. Depress the plunger 40, an additional time, against target area, squeeze the trigger 80 to activate the fastener driver 60, configured to install at least one additional fastener from the fastener holder 70, into the material 210 and the target area an additional time. The cutter button 200, configured to activate the cutter 50, and the cutter 50 configured to separate the material 210 in the track 30 from the material 210 in the holder 10. Separated from the material 210 in the holder 10, the material 210 exits through the track 30 without obstruction the majority of the time. The cutter button 200 configured to activate the advancer 110, the advancer 110 configured to reset the material 210 in the holder 10 past the plunger 40, for additional applications. With movement of the trigger 80, the light 190 illuminates the target area, and configured to turn off during inactivity. The power supply 160 of the present invention could be a portable power source, such as a battery.

Referring now to FIG. 7, comprises of the holder 10, the track 30, the plunger 40, the cutter 50, the fastener driver 60, the cutout 90, the fastener exit 100, the advancer 110, the roller 120, the power supply 160, and a fastener bit 180. FIG. 7 shows a cutaway view of track 30 from FIG. 6. The advancer 110 and the roller 120, configured to position the material 210 in the holder 10, past the plunger 40. The fastener driver 60 and the fastener bit 180, configured to insert at least one fastener through the fastener exit 100 into the material 210 and the target area. Secured by at least one fastener at one end of the material 210 and the target area, hold the grip 20 and pull the present invention to dispense the material 210 from the holder 10 and through the track 30, to secure an item, such as a duct, a cable or a pipe. Depress the plunger 40 against the target area an additional time, activate the fastener driver 60 and the fastener bit 180 with the trigger 80, shown in detail in FIG. 6, to insert at least one fastener through the fastener exit 100 into the material 210 and the target area. The cutter button 200, shown in further detail in FIG. 6, configured to activate the cutter 50, and the cutter 50 configured to separate the material 210 in the track 30 from the material 210 in the holder 10. Separated from the material 210 in the holder 10, the material 210 in the track 30 exits through the track 30 without obstruction the majority of the time. The cutter button 200, as shown in FIG. 6, configured to activate the advancer 110, wherein the advancer 110, configured to reset the material 210 from the holder 10, and position the material 210 past the plunger 40, for additional applications. The power supply 160 of the present invention could be a battery, configured to activate the fastener driver 60.

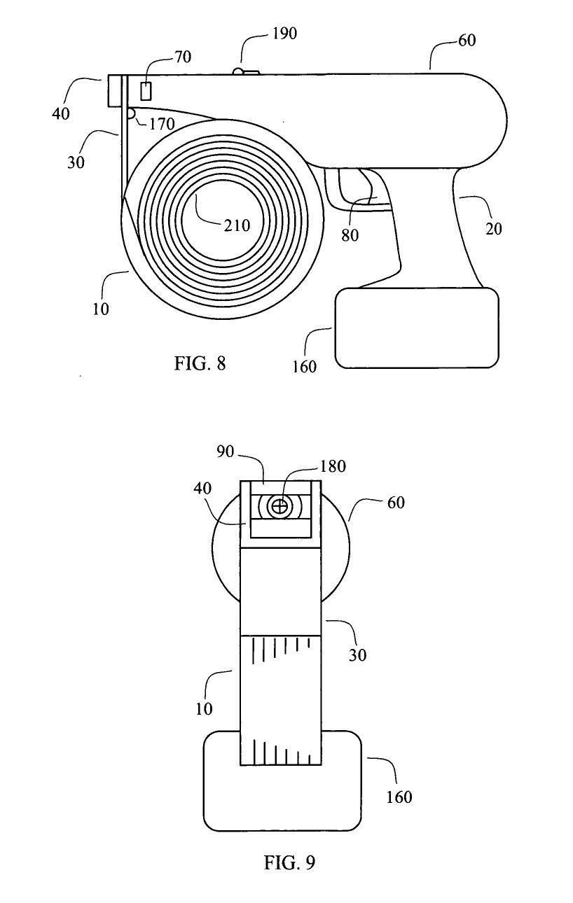

Now referring to FIG. 8, in another embodiment, comprising of the holder 10, the grip 20, the track 30, the plunger 40, the fastener driver 60, the fastener holder 70, the trigger 80, the power supply 160, a tension adjuster 170, the light 190, and the material 210. The material 210, configured to be manually positioned, and move through the track 30, past the plunger 40. While holding the grip 20, depress the plunger 40 against the target area, squeeze the trigger 80, to activate the fastener driver 60, configured to install at least one fastener from the fastener holder 70 through the fastener exit 100, into the material 210 and the target area. Secured by a fastener at one end of the material 210 to the target area, pull the present invention to dispense the material 210 around an item to secure. Depress the plunger 40, an additional time against the target area, squeeze the trigger 80 to activate the fastener driver 60, configured to install at least one fastener into the material 210 and the target area an additional time. Severe the material 210, between the additional fastener and the present invention to separate the material 210 at the target area from the material 210 in the track 30. The tension adjuster 170, configured to apply various pressures to the material 210 and inhibit the material 210 from retreating into the track 30. With movement of the trigger 80, the light 190 illuminates the target area, and configured to turn off during inactivity. The power supply 160 of the present invention could be a portable power source, such as a battery. However, the power source could be a spring activated plunger or an external power supply.

Referring now to FIG. 9, comprises of the holder 10, the track 30, the plunger 40, the fastener driver 60, the cutout 90, the fastener exit 100, the power supply 160, and the fastener bit 180. Configured to be manually positioned from the holder 10, through the track 30 and past the plunger 40. The fastener driver 60 and the fastener bit 180, configured to insert at least one fastener through the fastener exit 100, and into the material 210 and the target area. Secured by at least one fastener at one end of the material 210 to the target area, pull the present invention to dispense the material 210 from the holder 10 and through the track 30, to secure an item, such as a duct, a cable or a pipe. Depress the plunger 40 against the target area an additional time, activate the fastener driver 60 and the fastener bit 180 with the trigger 80, shown in detail in FIG. 8, configured to insert at least one additional fastener through the fastener exit 100, into the material 210 and the target area. The material 210, with at least one fastener installed configured to exit the cutout 90 unobstructed, the majority of the time, wherein the operator could severe the material 210 between the additional fastener and the present invention, to reset the material 210 in the track 30 for additional applications. The fastener driver 60, configured to operate with the power supply 160. The power supply 160 of the present invention could be a portable power source, such as a battery.

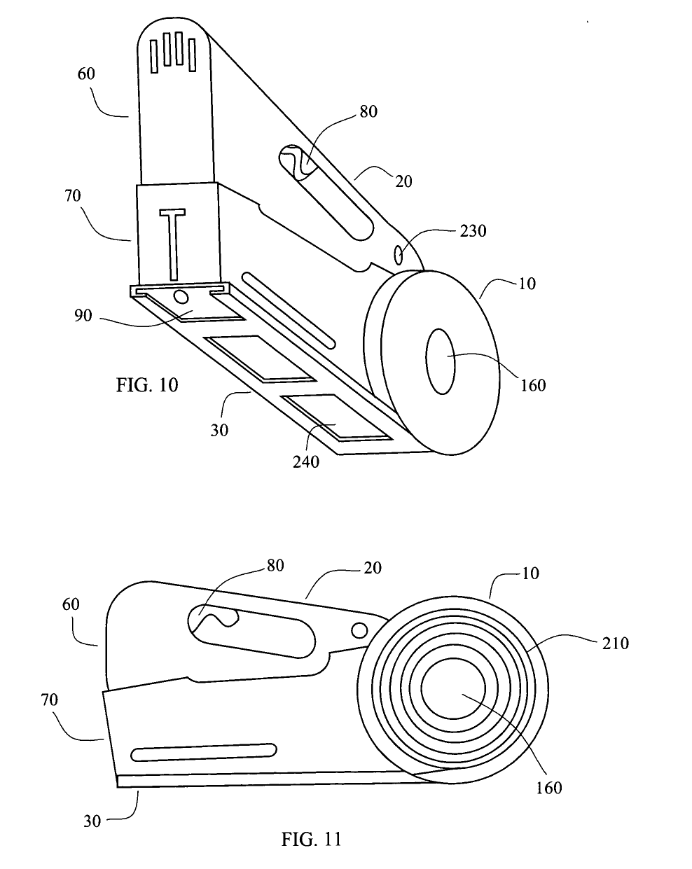

Referring now to FIGS. 10 and 11, the material 210, configured to be manually positioned in the holder 10, through the track 30, routing the material 210 via an access hole 240, in track 30, and past the cutout 90. Depress the present invention against the target area, wherein the fastener driver 60 moves in a cycle from a driver pivot 230, and configured to dispense at least one fastener from at least one end of the fastener driver 60. The fastener driver 60, configured to insert at least one fastener into the material 210 and the target area. At least one end of the material 210 secured by at least one fastener to the target area, and pulling the present invention to dispense the material 210 from the holder 10, and through the track 30, will dispense the material 210 to secure an item, such as a duct, a cable or a pipe. Depress the present invention against the target area an additional time, activate the fastener driver 60 with the trigger 80 in the grip 20, to insert at least one additional fastener into the material 210, and the target area. The material 210, with at least one fastener installed configured to exit the cutout 90 unobstructed, the majority of the time. Wherein the operator could severe the material 210 between the additional fastener and the present invention, to reset the material 210 in the track 30 for additional applications. The fastener holder 70, configured to retain at least one fastener for the fastener driver 60 to dispense. The fastener driver 60, configured to operate with the power supply 160.

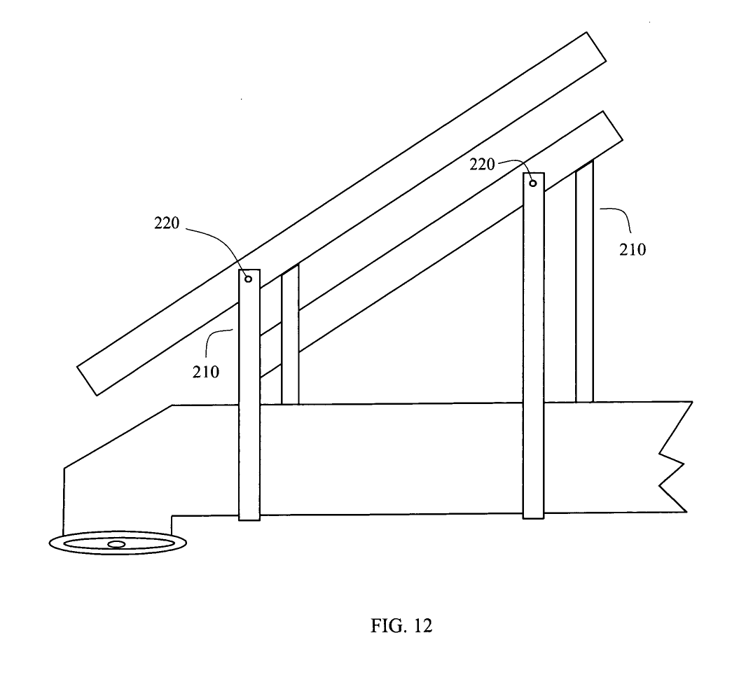

Referring to FIG. 12, which shows an installation of the material 210, supporting a duct. The material 210 secured with at least one fastener, which in FIG. 10 is a screw 220. The fastener could be a nail, a staple, and other fasteners know to the art to secure an item. The screw 220 secures the material 210 to the target area, which in FIG. 10 is a wooden structure. However, the present invention is not limited to a specific target material, and the wooden structure is used for clarification. The material 210 comprising of any material known in the art to secure an item. The material 210 could be a continuous roll or a measured length of material.

We claim:

1. A duct securing gun, comprising:
a holder for retaining a material;
a track for aligning the material;
a fastener holder;
a fastener driver for installing a fastener in the material;
a cutter for separating the material dispensed from the material retained in the holder;
an advancer movable in a revolving cycle with respect to at least one of the holder, the track, the fastener holder, the fastener driver, and the cutter, wherein for a portion of the cycle the material moves freely to exit one end of the track.

2. The fastener driver as claimed in claim 1, further comprising a trigger to activate the fastener driver, the advancer, and the cutter, wherein the fastener driver and the cutter completes a cycle, the advancer is configured to move the material through the track.

3. The track as claimed in claim 1, wherein the advancer moves material from the holder through the track.

4. The cutter as claimed in claim 1, further comprising a cutter button, wherein the cutter button activates the cutter, the majority of the time.

5. The fastener driver as claimed in claim 1, further comprising a light for illumination.

6. The track as claimed in claim 1, further comprising at least one of an exit.

7. The track as claimed in claim 1, further comprising at least one of an entrance.

8. The track as claimed in claim 1, further comprising at least one cutout, wherein the fastener and the material exit the track unobstructed.

9. The holder as claimed in claim 1, wherein the holder is configured to dispense the material.

10. The track as claimed in claim 1, wherein the material is configured to move through the track.

11. A duct securing gun, comprising:
a holder for retaining a material;
a fastener driver for installing at least one fastener;
a track to align the material with respect to at least one of the holder, and the fastener driver,
wherein the fastener driver installs at least one fastener to secure at least one end of the material.

12. The holder as claimed in claim 11, wherein the material in the holder moves freely through the track.

13. The track as claimed in claim 11, further comprising a tension adjuster, wherein the tension adjuster applies various pressures to inhibit the material from retracting.

14. The track as claimed in claim 11, further comprising at least one access hole to position the material.

15. The fastener driver as claimed in claim 11, wherein at least one end of the fastener driver pivots.
